(19) United States
(12) Patent Application Publication
(10) Pub. No.: US 2006/0146870 A1
(43) Pub. Date: Jul. 6, 2006

(54) Transparent communication with IPv4 private address spaces using IPv6

(76) Inventors: George A. Harvey, Bedford, MA (US); Ying-leh Lin, Franklin, MA (US)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 11/026,157

(22) Filed: Dec. 30, 2004

(51) Int. Cl. H04J 3/22; H04J 3/16

(52) U.S. Cl. 370/466

(57) ABSTRACT

The present invention provides for facilitating establishment of communication with Internet protocol version four (IPv4) private addresses of IPv4 nodes of private networks by using Internet protocol version six (IPv6). In one of many possible embodiments, a gateway is configured to connect an IPv4 private address of a private network node with a public network. The gateway is assigned a globally routable IPv4 address. The gateway is further configured to generate a globally routable IPv6 address based on the IPv4 private address of the IPv4 node and the globally routable IPv4 address of the gateway.

### BACKGROUND

Internet Protocol version four (IPv4) has long been an accepted standard used for IP-based networks, such as the Internet. Unfortunately, IPv4 suffers from several limitations that are becoming more apparent in light of the proliferation of devices communicating over the Internet. One especially troublesome limitation of IPv4 is its limited address space. IPv4 supports only 32-bit addresses, so there are only 232 unique addresses available in an IPv4 network. The unique IPv4 addresses are becoming scarce as the number of devices connecting to the Internet continues to increase.

One approach commonly used to get around the problem of limited IPv4 addresses is the allocation of private address spaces for use in private networks. Nodes in private networks are able to use private addresses selected from allocated IPv4 private address spaces. However, addresses in the private network spaces are not globally routable (i.e., not globally unique) because many nodes from different private networks share the same private addresses.

Network Address Translation (NAT) is commonly used to allow nodes having addresses in the private address spaces of IPv4 private networks to initiate connections to other devices over the Internet. A router, gateway, or similar device that connects the private network to the Internet, performs the NAT function to share a single, globally routable IPv4 address (e.g., the IPv4 address of the router) among the nodes of the private network. This setup allows the nodes of the private address network to use the router's globally unique IPv4 address to communicate with other nodes on the Internet.

However, NAT is not without limitations. For example, the nodes of the private network must either take turns because only one node at a time can use the router's global IPv4 address, or have their private addresses mapped to the single, global IPv4 address and their transport layer ports mapped to unique transport layer ports not already in use by another node. Further, NAT does not permit all of the nodes in the private network to receive incoming connections from nodes outside of the private network because the NAT router does not know to which node in the private network to direct an incoming connection. This prevents establishing a connection between a pair of nodes when each of the nodes is in a separate private network because neither node will be able to receive an incoming connection from the other node.

To alleviate the problems created by the limitations of IPv4, Internet Protocol version six (IPv6) is being promoted as a replacement for IPv4. IPv6 includes a 128-bit address space, or 2¹²⁸ available unique addresses. While the increased address size of IPv6 relieves the problem of insufficient unique network-layer addresses, IPv4 devices are already widely deployed across many networks. Accordingly, standards and protocols have been provided to help establish interoperation of IPv4 and IPv6 networks during the transition from IPv4 to IPv6 networks. Documented techniques exist for encapsulating IPv4 addresses inside of IPv6 addresses, tunneling IPv6 packets across IPv4 networks, and translating protocols between IPv4 and IPv6 networks.

Unfortunately, conventional techniques for interfacing IPv4 and IPv6 networks do not fully address all relevant issues. For example, some nodes of private networks are still unable to receive incoming connections from nodes outside of the same private network. One reason for this is that conventional techniques for translating IPv4 addresses to IPv6 addresses assume that the IPv4 addresses are globally unique. As a result, conventional translation techniques are incapable of creating globally unique IPv6 addresses from IPv4 private network space addresses. Assuming that IPv4 addresses are unique is an ineffective approach when dealing with non-unique private address networks, which make up a large portion of currently deployed devices communicating over IP-based networks. Further, conventional translation techniques do not map IPv6 addresses to private space addresses in IPv4 private networks. Because of the foregoing problems, conventional techniques for interfacing IPv4 and IPv6 networks are incapable of receiving connections from IPv4 nodes in different IPv4 private networks, or even from a public IPv4 or IPv6 node.

### SUMMARY

In one of many possible embodiment, the present invention provides for facilitating establishment of communication with Internet protocol version four (IPv4) private addresses of IPv4 nodes of private networks by using Internet protocol version six (IPv6). A gateway is configured to connect an IPv4 private address of a private network node with a public network. The gateway is assigned a globally routable IPv4 address. The gateway is configured to generate a globally routable IPv6 address based on the IPv4 private address of the IPv4 node and the globally routable IPv4 address of the gateway.

Another embodiment of the present invention provides for facilitating establishment of communication with Internet protocol version four (IPv4) private addresses of IPv4 nodes of private networks by using Internet protocol version six (IPv6). A gateway is configured to connect a particular IPv4 node with a public network. The gateway is assigned a globally routable IPv4 address. The gateway is configured to receive a message over the public network. The message includes a globally routable source address in IPv6 format. The gateway is further configured to allocate an unused IPv4 private address from a predefined private address space of the private network, and to create a mapping, which mapping associates the unused IPv4 private address with the globally routable source address.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 is a block diagram illustrating a system providing a transparent connection between a pair of Internet Protocol version four (IPv4) nodes in separate private networks, according to one embodiment.

FIG. 2 is a block diagram illustrating addresses used for establishing a connection between a pair of IPv4 nodes of the system of FIG. 1, according to one embodiment.

FIGS. 3 and 4 are flowcharts illustrating a method of establishing a transparent connection between IPv4 nodes in the separate private networks of FIG. 1, according to one embodiment.

FIG. 5 is a block diagram illustrating a system providing a transparent connection between a public Internet Protocol version six (IPv6) node and an IPv4 node in a private network, according to one embodiment.

FIG. 6 is a block diagram illustrating addresses used for establishing a connection between an IPv6 node and an IPv4 node of the system of FIG. 5, according to one embodiment.

FIG. 7 is a flowchart illustrating a method of establishing transparent communication between an IPv6 node and an IPv4 node of the system of FIG. 5, according to one embodiment.

Throughout the drawings, identical reference numbers designate similar, but not necessarily identical, elements.

### DETAILED DESCRIPTION

The present specification discloses a system, method, and apparatus for providing transparent communication between an IPv4 private address node in a first private network and a node external to the first private network, over a public network. The external node may be a publicly routable node (e.g., a publicly routable IPv6 or IPv4 node connected to the Internet) or a private node in another private network (e.g., an IPv4 node in another private network). IPv4 private addresses are mapped to IPv6 globally routable (i.e., unique) addresses, with each of the IPv6 globally routable addresses including the IPv4 address of the associated node in the private network, as well as the IPv4 globally routable address of a gateway (or similar device) that connects the private address node to an external network (e.g., the Internet). With a globally routable IPv6 address assigned to an IPv4 private network node, the node is able to send and receive connections via the gateway by using the globally routable IPv6 address.

Further, mappings are generated from the unique IPv6 addresses of external nodes (e.g., nodes in other private networks) into local IPv4 address spaces to develop routing tables for routing to and from the private nodes connected to the gateway. The above-mentioned functions and features support the establishment of transparent connections with IPv4 private network nodes. In particular, the IPv4 private network nodes are able to receive incoming connections from nodes outside of the private network.

I. Connections Between IPv4 Nodes in Independent Private Networkds

A. System Overview

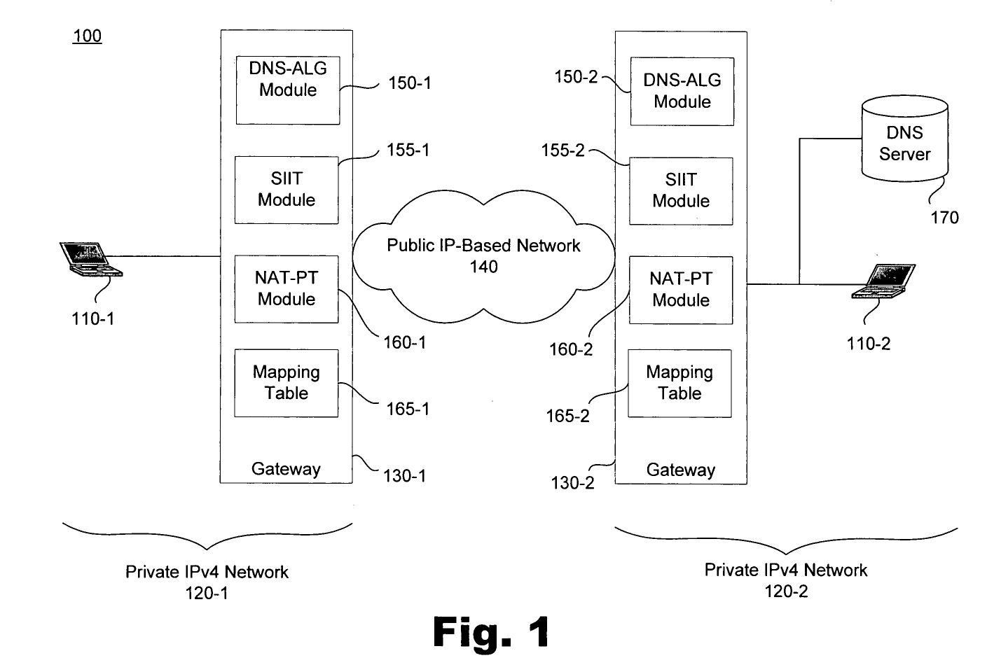

FIG. 1 is a block diagram illustrating a system (100) providing transparent communication between a pair of Internet Protocol version four (IPv4) nodes (110-1, 110-2) in separate private networks (120-1, 120-n), according to one embodiment. As shown in FIG. 1, the IPv4 node (110-1) in the private IPv4 network (120-1) is connected to a gateway (130-1). The gateway (130-1) communicatively couples the IPv4 node (110-1) to a public IP-based network (140). Similarly, the IPv4 node (110-2) in the private IPv4 network (120-2) is communicatively coupled to the public IP-based network (140) by a gateway (130-2). The elements of FIG. 1 will now be discussed in greater detail.

1. IPv4 Nodes

The IPv4 nodes (110-1 and 110-2) (collectively “the IPv4 nodes 110”) may comprise any device capable of being assigned an IPv4 address, and in particular an IPv4 address from a private address space. Examples of such devices include, but are not limited to, personal computers, workstations, IP-based telephones, personal digital assistants, e-mail devices, pagers, set-top boxes, dedicated computing devices, and other IP-capable devices.

Each of the IPv4 nodes (110-1, 110-2) is arranged in one of the respective private IPv4 networks (120-1, 120-2). Accordingly, the IPv4 nodes (110) may each be assigned a private address within spaces of IPv4 addresses that have been allocated for use in private networks, as known to those skilled in the art.

While FIG. 1 shows only one IPv4 node (110-1) in the private IPv4 network (120-1) and one IPv4 node (110-2) in the private IPv4 network (120-2), those skilled in the art will readily understand that each of the private IPv4 networks (120-1 and 120-2) may include multiple IPv4 nodes (110). The number of IPv4 nodes (110) in each private IPv4 network (120-1 and 120-2) may exceed the number of allocated unique private addresses by duplicating the private addresses and using known network address translation (NAT) mechanisms.

2. Gateways

The gateways (130-1 and 130-2) (collectively referred to as “the gateways 130”) are each arranged to communicatively couple their respective IPv4 nodes (110) to the public IP-based network (140). As shown in FIG. 1, the gateways (130) are connected to their respective IPv4 nodes (110) and to the public IP-based network (140). The gateways (130) may include any known device or devices useful for communicatively coupling the IPv4 nodes (110) to the public IP-based network (140). For example, the gateways (130) may comprise, but are not limited to, routers, switches, modems, gateways, and the like.

The gateways (130) are capable of being assigned IPv4 addresses. Because the gateways (130) are configured to communicate directly over the public IP-based network (140), the gateways (130) are assigned globally routable (i.e., globally unique) IPv4 addresses, according to standards and procedures known to those skilled in the art.

The gateways (130) include mechanisms and instructions for establishing transparent communications between the IPv4 nodes (110) of the separate private IPv4 networks (120-1 and 120-2). The mechanisms and instructions may be arranged in any suitable manner within the gateways (130). For example, FIG. 1 shows the gateways (130-1 and 130-2) to include Domain Name System Application Layer Gateway (DNS-ALG) modules (150-1 and 150-2) (collectively “the DNS-ALG modules (150)”), Stateless IP/ICMP Translation (SIIT) modules (155-1 and 155-2) (collectively “the SIIT modules (155)”), and Network Address Translation Protocol Translation (NAT-PT) modules (160-1 and 160-2) (collectively “the NAT-PT modules (160)”). These modules (150, 155, and 160) are configured to work together to establish transparent communication between the IPv4 nodes (110) of the separate private IPv4 networks (120-1 and 120-2).

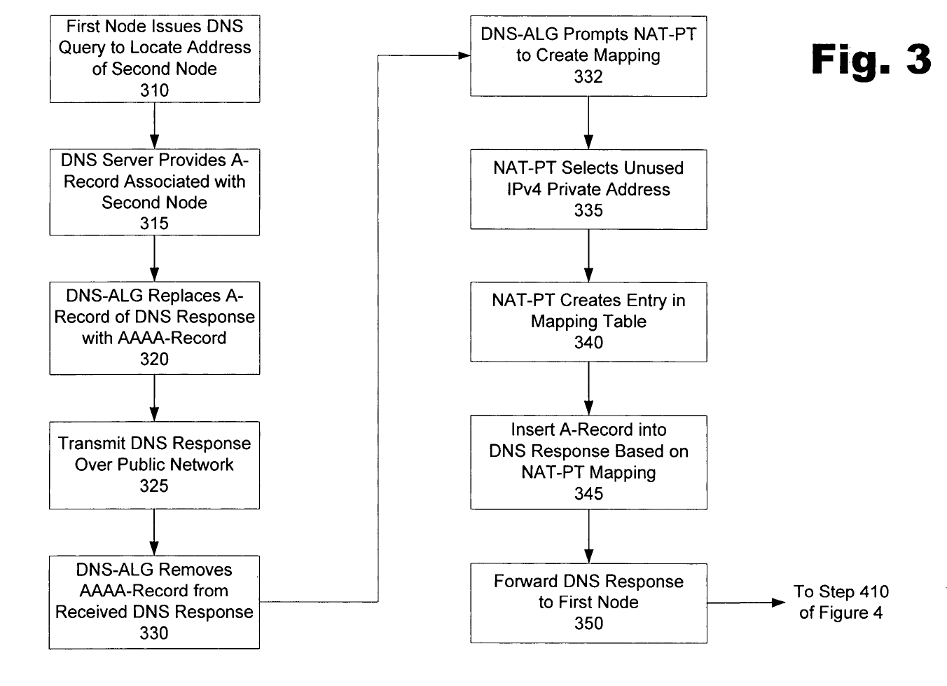

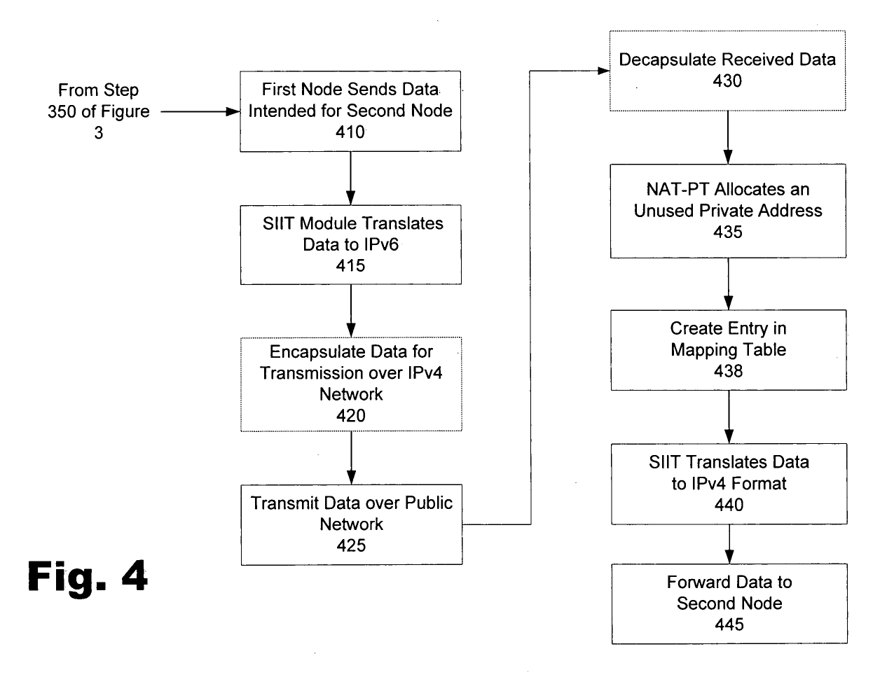

The mechanisms and instructions of the gateways (130) may be embedded on processor-readable mediums and capable of instructing processors (not shown) to execute steps for establishing transparent connections between the IPv4 nodes (110), as discussed below. In alternative embodiments, the mechanisms and instructions mentioned above may be located external to the gateways (130). Whether the mechanisms and instructions are external or internal to the gateways (130), the gateways (130) are able to access the instructions and use the mechanisms to establish transparent communication between the IPv4 nodes (110). Several functions of the modules (150, 155, and 160) will now be described in more detail. These and other functions performed by the gateways (130) to establish transparent communication between the IPv4 nodes (110) of independent private IPv4 networks (120-1 and 120-2) will also be described in greater detail below with reference to FIGS. 3 and 4.

a. DNS-ALG Module

The DNS-ALG module (150) of the gateway (130) is configured to modify the IP address content of DNS protocol messages to enable the DNS messages to cross the boundary between the different IPv4 and IPv6 addressing realms. When a DNS message is traveling from the private side of the gateway (130) to the public side of the gateway (130), the DNS-ALG module (150) is configured to replace the “A-Record” of the IPv4 DNS message with an appropriate “AAAA-Record” to convert addresses in the DNS message to IPv6 format. For DNS messages traveling from the public side of the gateway (130) to the private side of the gateway (130), the DNS-ALG module (150) prompts the NAT-PT module (160) to create an entry in a mapping table (165) from the IPv6 address in the “AAAA-Record” to an unused IPv4 address in the private address space if a mapping does not already exist in the mapping table 165. The DNS-ALG module (150) then replaces the “AAAA-Record” with the appropriate “A-Record” containing the IPv4 format address from the mapping table (165) for delivery to the nodes (110) in the private network (120). DNS messages, “A-Records,” and “AAAA-Records” are well-known to those skilled in the art.

The DNS-ALG module (150) is configured to generate globally unique IPv6 addresses for inclusion in the “AAAA-Records” that are inserted into the DNS messages. This is done by converting IPv4 addresses to IPv6 addresses, which conversion may be performed according to predefined heuristics for creating one-to-one mappings between IPv4 addresses of the private IP-based network (120) and a unique, well-defined subset of the IPv6 address space. The mapping procedures are defined to generate unique IPv6 addresses by basing each particular mapping on the IPv4 address of the associated IPv4 node (110) and the IPv4 address of the IPv4 node's (110) gateway (130). In other words, the generated IPv6 address includes both the IPv4 address of the associated IPv4 node (110) and the IPv4 address of the IPv4 node's (110) gateway (130). The generated IPv6 addresses are unique (i.e., globally routable) because the IPv4 address of the gateway (130) is unique.

The mappings of IPv4 addresses to IPv6 addresses should be performed in compliance with accepted protocols and standards for IPv6 addressing. For example, the mapping heuristics may be configured to comply with procedures defined for IPv6-to-IPv4 (“6-to-4”) tunneling as defined in Request For Comments (RFC) 3056 and for IPv4-mapped IPv6 addressing defined in RFC 3513. The contents of RFC 3056 and RFC 3513 are hereby incorporated by reference in their entirety.

In addition, the IPv4 addresses of the IPv4 node (110) and the gateway (130) should be embedded in the generated IPv6 address by using any accepted global IPv6 prefix followed by the IPv4 addresses for the gateway (130) and the IPv4 node (110). In one embodiment, the DNS-ALG module (150) uses the “2002::/16” prefix assigned for 6-to-4 tunneling by the Internet Assigned Numbers Authority (IANA).

For example, if the globally routable IPv4 address of the gateway (130) is denoted symbolically as “Global-v4-Addr,” and the IPv4 address of the IPv4 node (110) is denoted symbolically as “Private-v4-Addr,” the DNS-ALG module (150) may map the unique and globally routable IPv6 address of “2002:Global-v4-Addr::ffff:Private-v4-Addr” to the IPv4 node (110). The “::ffff:Private-v4-Addr” portion of the IPv6 address is for use by the SIIT for IPv4-mapped IPv6 addresses to refer to IPv4-only nodes, as discussed below. The system (100) is not limited to the particular example given above. The IPv4 addresses of the gateway (130) and the IPv4 node (110) may be embedded in an IPv6 address in many different ways without departing from the spirit or scope of the invention.

The generation of unique IPv6 addresses from private IPv4 addresses is described below in the context of an example of a method for establishing a transparent connection between the IPv4 nodes (110-1 and 110-2). In any event, the DNS-ALG module (150) is configured to generate a unique and globally routable IPv6 address based on the IPv4 addresses of the private IPv4 node (110) and its gateway (130). The DNS-ALG module (150) is able to insert the unique IPv6 address into the “AAAA-Record” of an appropriate DNS message, as discussed above.

b. SIIT Module

The SIIT modules (155) include instructions for translating between IPv4 and IPv6 packet headers. The SIIT modules (155) may include instructions for translating as defined in RFC 2765, the contents of which are hereby incorporated by reference in their entirety. Because the SIIT modules (155) are capable of translating IPv6 addresses to appropriate IPv4 addresses, data that arrived by way of IPv6 addresses can be forwarded to appropriate IPv4 addresses of the private network (120). For data traveling in the other direction (i.e., from private-side to public-side), the SIIT modules (155) are able to translate IPv4 packet headers to IPv6 format.

c. NAT-PT Module

The NAT-PT modules (160) are configured to combine known Network Address Translation (NAT) techniques with known SIIT techniques. In one embodiment, the NAT-PT modules (160) are configured to perform address translation functions as defined in RFC 2766, the contents of which are hereby incorporated by reference in their entirety.

In addition, when an incoming connection arrives with a destination identified by an IPv6 address, the particular NAT-PT module (160) determines the private address of the intended destination node (110) by parsing the IPv6 address to extract the embedded private space IPv4 destination address.

Each of the NAT-PT modules (160) is configured to create appropriate mappings between IPv4 and IPv6 addresses. For example, the NAT-PT module (160-1) is able to create mappings for IPv6 addresses on the public side of the gateway (130-1) to unused IPv4 addresses from the private address space on the private side of the gateway (130-1). The mappings may be stored in a particular mapping table (165-1 or 165-2) associated with the particular NAT-PT module (160). The mapping tables (165-1 and 165-2) (collectively “the mapping tables (165)”) may be stored on any suitable computer-readable medium or mediums that are accessible by the associated NAT-PT module (160).

By creating a mapping table that associates public IPv6 addresses with private IPv4 addresses, the gateways (130) are able to provide private space addresses for the sources of incoming connections. When an incoming connection or packet arrives from a source identified by an IPv6 address, the particular NAT-PT module (160) can consult the mapping table (165) to determine the private address to be used for that source. If there is no entry in the mapping table (165) for the source IPv6 address, the NAT-PT module (160) is configured to create an entry and associate the source IPv6 address with an unused IPv4 private address. The entry is stored in the mapping table (165). The gateway (130) is prepared to route subsequent packets originated from within the private network (120) to the IPv6 destination address by referencing the mapping table (165). In addition, the gateway (130) is configured to provide the appropriate private space IPv4 source address for packets received from the public network (140) destined for nodes (110) in the private network (120).

The mappings in the mapping tables (165) may be used to identify appropriate IPv4 addresses to be inserted into the “A-Records” by the DNS-ALG modules (150). Examples of the insertion of addresses identified from the mappings into “A-Records” will be described below. The operation of the modules (150, 155, and 160) and the mapping tables (165) are also described in greater detail below.

3. Private IPv4 Networks

The private IPv4 networks (120-1 and 120-2) (collectively referred to as the private IPv4 networks 120) may communicate over the public IP-based network (140). As shown in FIG. 1, the private networks (120) include one or mode IPv4 nodes (110) connected to the gateways (130), which provide access to the public IP-based network (140).

The private IPv4 networks (120-2) may include Domain Name System (DNS) servers. DNS servers are well-known to those skilled in the art and are used to associate domain names with specific IP addresses, thereby allowing specified domain names to be located at the appropriate addresses that have been predefined as being associated with the domain names. As shown in FIG. 1, the private IPv4 network (120-2) includes a (DNS) server (170).

While FIG. 1 shows only two private IPv4 networks (120-1 and 120-2) connected to the public IP-based network (140), those skilled in the art will recognize that additional private IPv4 networks (120) may be connected to the public IP-based network (140). Further, one or more DNS servers (170) may be included in any of the private IPv4 networks (120) of the system (100).

4. Public IP-Based Network

The public IP-based network (140) may include any publicly accessible EP-compatible network. The public IP-based network (140) should be capable of supporting communication between devices having globally routable IPv4 address (e.g., the gateways (130)). In one embodiment, the public IP-based network (140) comprises the Internet.

B. Example of a Method for Establishing Transparent Communication

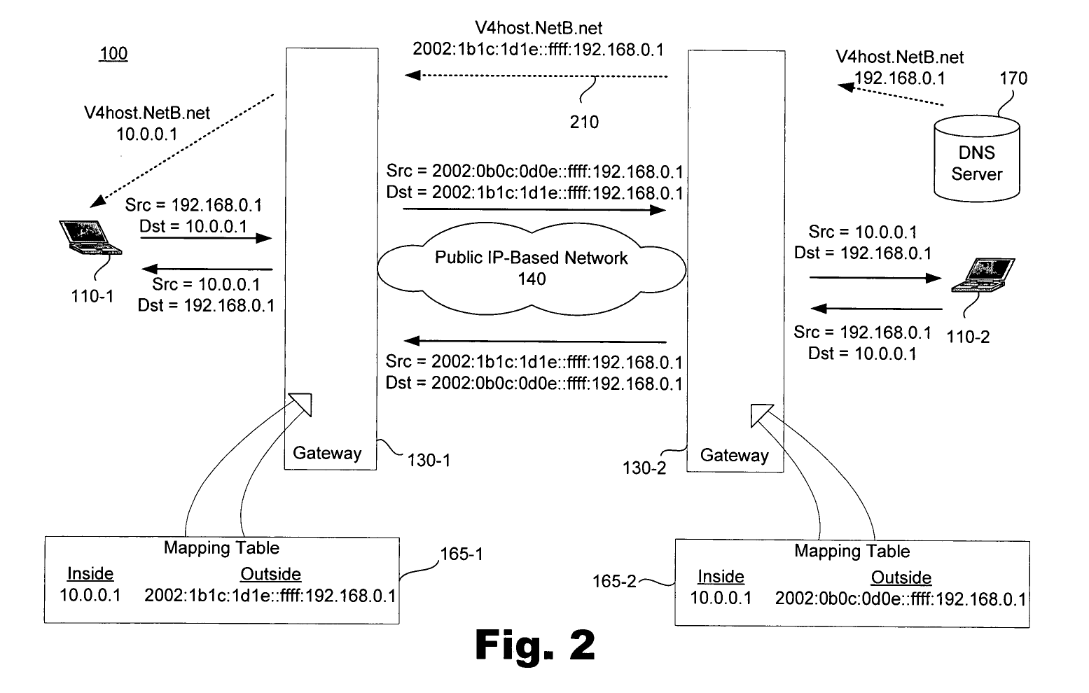

FIG. 2 is a block diagram illustrating address creations, translations, and mappings used to establish a peer connection between a pair of IPv4 nodes (110) of the system (100) of FIG. 1, according to one embodiment. In the embodiment shown in FIG. 2, the IPv4 nodes (110-1 and 110-2) are assumed to have been assigned the fully qualified domain names of “V4host.NetA.net” and “V4host.NetB.net” respectively. Each of the IPv4 nodes (110) is also assumed to have been assigned an IPv4 address that is unique within each respective private IPv4 network (120). Because the private IPv4 networks (120-1 and 120-2) are independent, FIG. 2 shows a case in which each of the IPv4 nodes (110-1 and 110-2) has been assigned the identical private address of “192.168.0.1” to illustrate that the method shown in FIGS. 3 and 4 is effective even when an overlap occurs between the private addresses of the IPv4 nodes (110) in different private networks (120).

The gateways (130) of FIG. 2 have been assigned globally routable IPv4 addresses. Gateway (130-1) has been assigned “11.12.13.14,” and gateway (130-2) has been assigned “27.28.29.30.” Each of the gateways (130) of FIG. 2 has also been assigned an IPv6 prefix based on the IPv4 addresses of the gateways (130). Gateway (130-1) has been assigned the IPv6 prefix “2002:0b0v:0d0e:0/64,” and gateway (130-2) has been assigned the IPv6 prefix “2002:1b1c:1d1e:0/64.” The format of the IPv6 prefix is well-known to those skilled in the art. The addresses shown in FIG. 2 will be better understood with reference to the following discussion of FIGS. 3 and 4. For this example, the pool of private addresses available for each of the private IPv4 networks (120) is assumed to be “10/8,” as understood by those skilled in the art.

FIGS. 3 and 4 are flowcharts illustrating an example of a method of establishing transparent communication between the IPv4 nodes (110; FIG. 1) in the separate private networks (120; FIG. 1) of FIG. 1, according to one embodiment. At step (310) of FIG. 3, a first node (e.g., IPv4 node (110-1; FIG. 1)) issues a query to the domain name system (DNS) to resolve the name, “V4host.NetB.net,” of a second node (e.g., IPv4 node (110-2; FIG. 1)) to an IP address, as understood by those skilled in the art. DNS server (170; FIG. 1) is the authoritative DNS server for the name “V4host.NetB.net,” so the query is directed to DNS server (170; FIG. 1) in the private IPv4 network (120-2; FIG. 1).

At step (315), the DNS server (170; FIG. 1) responds to the query by providing an “A-record” associated with the name “V4host.NetB.net.” The “A-Record” includes the local IPv4 address of “192.168.0.1” used in the private IPv4 network (120-2; FIG. 1) to identify the IPv4 node (110-2; FIG. 1).

At step (320), the DNS-ALG module (150-2; FIG. 1) of the gateway (130-2; FIG. 1) removes the “A-record” from the response and replaces the “A-record” with an “AAAA-record.” The “AAAA-record” includes a unique and globally routable IPv6 address generated by the DNS-ALG module (150-2; FIG. 1), as discussed above. In FIG. 2, the IPv6 address includes the IPv6 prefix “2002:1b1c:1d1e:0/64” in commonly accepted form, which prefix is descriptive of the globally routable IPv4 address (27.28.29.30) of the gateway (130-2; FIG. 1). The IPv6 address also includes the private address (192.168.0.1) of the IPv4 node (110-2; FIG. 1), which private address is received from the DNS server (170; FIG. 1). The IPv6 prefix and the private address are arranged to form the globally unique and routable IPv6 address that can be used on the public side of the gateway (130-2; FIG. 1) to identify the IPv4 node (110-2; FIG. 1). As shown in FIG. 2, the “AAAA-record” inserted into the DNS response includes the IPv6 address of “2002:1b1c:1d1e::ffff:192.168.0.1.”

At step (325) of FIG. 3, the DNS response is sent from the gateway (130-2; FIG. 1), through the public IP-based network (140; FIG. 1), to the gateway (130-1; FIG. 1), as shown by the path (210) in FIG. 2.

At step (330) of FIG. 3, the DNS-ALG (150-1; FIG. 1) of the gateway (130-1; FIG. 1) removes the “AAAA-record” from the received DNS response. At step (332), the DNS-ALG (150-1; FIG. 1) prompts the NAT-PT module (160-1; FIG. 1) to create a mapping in the mapping table (165-1; FIG. 1). The NAT-PT module (160-1; FIG. 1) is configured to respond to the prompting from the DNS-ALG module (150-1; FIG. 1) by performing steps (335) and (340) of FIG. 3.

At step (335), the NAT-PT module (160-1; FIG. 1) may select an unused IPv4 address from the private address space of the private IPv4 network (120-1; FIG. 1). For example, the NAT-PT may identify and select an unused address of “10.0.0.1” from the private address space. Many techniques may be used for identifying and selecting an unused private address.

At step (340), the NAT-PT module (160-1; FIG. 1) creates an entry in the mapping table (165-1; FIG. 1). The entry maps the selected IPv4 private address of the private network with the associated IPv6 public address on the public network side of the gateway (130-1; FIG. 1). In FIG. 2 for example, the mapping table (165-1) includes an entry mapping “10.0.0.1” on the private side to “2002:1b1c:1d1e::ffff:192.168.0.1” on the public side. Once the entry is created in the mapping table (165-1; FIG. 1), the NAT-PT module (160-1; FIG. 1) returns the private address (e.g., “10.0.0.1”) selected in step (335) to the DNS-ALG (150-1; FIG. 1).

At step (345) of FIG. 3, the DNS-ALG (150-1; FIG. 1) inserts an “A-record” containing the selected private address (e.g., “10.0.0.1”) into the DNS response based on the mapping in the mapping table (165-1; FIG. 1). At step (350), the DNS response is forwarded to the first node (i.e., IPv4 node (110-1; FIG. 1)), which issued the DNS query in step (310). By creating and storing a mapping between a private-side address (e.g., “10.0.0.1”) and the associate public address (e.g., “2002:1b1c:1d1e::ffff:192.168.0.1”), the gateway (130-1; FIG. 1) allows data packets sent from the IPv4 node (110-1; FIG. 1), or from other nodes in the private IPv4 network (120-1; FIG. 1), to destination address “10.0.0.1” to be translated and forwarded to the IPv4 node (110-2; FIG. 1) associated with the address “192.168.0.1.” With the appropriate entry in the mapping table (165-1; FIG. 1), the gateway (130-1; FIG. 1) is able to perform SIIT mappings and address translations to deliver data packets to private addresses.

Processing may continue at step (410) of FIG. 4, which Figure describes steps for communicating a data packet from the first IPv4 node (110-1; FIG. 1) to the second IPv4 node (110-2; FIG. 1), according to one embodiment. At step (410), the first IPv4 node sends data intended for the second IPv4 node. For example, the IPv4 node (110-1; FIG. 1) may send the data intended for IPv4 (110-2; FIG. 1) to the gateway (130-1; FIG. 1). The data is typically in the form of packet data that includes a source IP address identifying the source node's address and a destination IP address identifying the destination node's address. In FIG. 2, the source IP address is “192.168.0.1,” and the destination IP address is “10.0.0.1.”

At step (415), the SIIT module (155-1; FIG. 1) of the gateway (130-1; FIG. 1) translates the source and destination IP headers contained in the transmitted data from IPv4 to IPv6 format using the address provided by the NAT-PT module (160-1; FIG. 1) found in the NAT-PT mapping table (165-1; FIG. 1) entries of the gateway (130-1; FIG. 1). In FIG. 2 for example, the destination IP address is translated into “2002:1b1c:1d1e::ffff:192.168.0.1” according to the entry in the mapping table (165-1) that associates “10.0.0.1” for the private side of the gateway (130-1; FIG. 1) with “2002:1b1c:1d1e::ffff:192.168.0.1” for the public side of the gateway (130-1; FIG. 1). The IPv4 source address and the IPv6 prefix for the gateway (130-1; FIG. 1) are used to generate the public-side source address of “2002:0b0c:0d0e:ffff:192.168.0.1” for identifying the source IPv4 node (110-1; FIG. 1) on the public side of the gateway (130-1; FIG. 1).

If the public IP-based network (140; FIG. 1) is an IPv4 network (e.g., the Internet), the data being sent is encapsulated for transmission over an IPv4 network at step (420) of FIG. 4. Any suitable IPv6-to-IPv4 (i.e., 6-to-4) encapsulation technique may be used. In one embodiment, the data is encapsulated according to the 6-to-4 rules defined in RFC 3056 with the source IPv4 address being 11.12.13.14 for the gateway (130-1; FIG. 1), and the destination IPv4 address being 27.28.29.30 for the gateway (130-2; FIG. 1) and the protocol type of “41,” as understood by those skilled in the art. The contents of RFC 3056 are hereby incorporated by reference in their entirety. If the public IP-based network (140; FIG. 1) is an IPv6 network, step (420) may be omitted.

At step (425), the gateway (130-1; FIG. 1) transmits the data over the public IP-based network (140; FIG. 1) to the gateway (130-2; FIG. 1). If the public IP-based network (140; FIG. 1) is an IPv4 network, the received data is decapsulated by a suitable 6-to-4 decapsulation technique at step (430). In one embodiment, the data is decapsulated according to the 6-to-4 rules defined in RFC 3056. If the public IP-based network (140; FIG. 1) is an IPv6 network, step (430) may be omitted.

At step (435), the NAT-PT module (160-2; FIG. 1) allocates an unused address from the private address space of the private network (120-2; FIG. 1) to be associated with the public-side source address contained in the received data packet, as discussed above. For example, the NAT-PT module (160-2; FIG. 1) may allocate “10.0.0.1” from the private address space. The unused address may be allocated when there is no entry containing the received source address (e.g., “2002:0b0c:0d0e::ffff:192.168.0.1”) in the NAT-PT mapping table (165-2; FIG. 1).

At step (438), the NAT-PT module (160-2; FIG. 1) creates an entry in the mapping table (165-2; FIG. 1) for the newly allocated address. In the case described above, the entry serves to map an IPv6 public-side address (e.g., “2002:0b0c:0d0e::ffff:192.168.0.1”) indicative of the source of the data with the selected unused private address (e.g., IPv4 private-side address “10.0.0.1”), as shown in FIG. 2. By storing this mapping entry into the NAT-PT mapping table (165-2; FIG. 1), subsequent communications that originate from nodes (110) in the private IPv4 network (120-2; FIG. 1) to the private space destination address “10.0.0.1” are mapped to “2002:0b0c:0d0e::ffff:192.168.0.1” based on the mapping table (165-2; FIG. 1), and can be readily routed to private node (110-1; FIG. 1) thereby allowing private IPv4 node (110-2; FIG. 1) to receive incoming connections from private IPv4 node (110-1; FIG. 1) and subsequently send communications to private IPv4 node (110-1; FIG. 1).

At step (440) of FIG. 4, the SIIT module (155-2; FIG. 1) of the gateway (130-2) translates the IP headers of the received data packet from IPv6 to IPv4 using addresses provided by the NAT-PT module (160-2; FIG. 1) of “10.0.0.1” from the mapping table (165-2; FIG. 1) for the source address and “192.168.0.1” extracted from “2002:1b1c:1d1e::ffff:192.168.0.1” for the destination address. “10.0.0.1” represents the source address of the IPv4 node (110-1; FIG. 1), and “192.168.0.1” is the private address identifying the IPv4 node (110-2; FIG. 1) to which the data is destined.

At step (445), the gateway (130-2; FIG. 1) forwards the data to the IPv4 node (110-2: FIG. 1) identified by the destination address “192.168.0.1” in the private IP-based network (120-2; FIG. 1).

The method shown in FIGS. 3 and 4 establishes mappings between private addresses and corresponding publicly routable IPv6 addresses. The mappings are stored in the gateways (130; FIG. 1) and are useful for establishing connections between IPv4 devices in independent private networks. Subsequent communications between IPv4 nodes (110-1 and 110-2; FIG. 1) are able to be forwarded to the indicated destinations by referencing NAT-PT mappings stored in the mapping tables (165; FIG. 1).

For example, the IPv4 node (110-2; FIG. 1) is able to send data packets to IPv4 node (110-1) by using the mapping created by the gateway (130-2; FIG. 1). In FIG. 2, the data sent by the IPv4 node (110-2; FIG. 1)) to the address “10.0.0.1” will be translated and forwarded to the gateway (130-1; FIG. 1) by the gateway (130-2; FIG. 1). The gateway (130-1; FIG. 1) includes an appropriate entry in its mapping table (165-1; FIG. 2) so that SIIT mappings and address translations are performed similar the above description in order to deliver the data sent by the IPv4 node (110-2) to the IPv4 node (110-1). Examples of source and destination addresses used for communications between the IPv4 nodes (110-1 and 110-2; FIG. 1) are shown in FIG. 2.

The method shown in FIGS. 3 and 4 may be implemented and used in many private networks, including already-deployed private networks.

II. Connections Between Public Nodes and Private IPv4 Nodes

A. System Overview

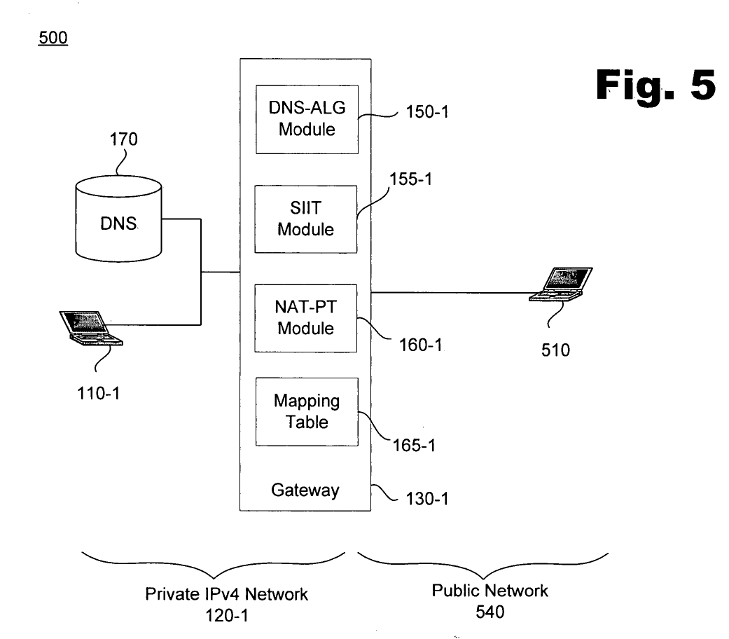

FIG. 5 is a block diagram illustrating a system (500) providing transparent communication between the IPv4 node (110-1) in the private network (120-1) and an Internet Protocol version six (IPv6) node (510), according to one embodiment. The system (500) includes the IPv4 node (110-1) connected to the gateway (130-1) as discussed above with reference to FIG. 1. The gateway (130-1) of the system (500) may be configured to include the mechanisms and instructions for operating as discussed above. In the system (500), the DNS server (170) is the authoritative DNS server for the private IPv4 network (120-1). As shown in FIG. 5, the gateway (130-1) is connected to a public network (540), which includes the IPv6 node (510).

1. IPv6 Node

The IPv6 node (510) may comprise any device or devices capable of being assigned an IPv6 address in the public network (540). The IPv6 address should be publicly routable, as understood by those skilled in the art. Examples of such devices include, but are not limited to, personal computers, workstations, IP-based telephones, personal digital assistants, e-mail devices, pagers, set-top boxes, dedicated computing devices, modems, routers, gateways, switches, and other IP-capable devices.

While FIG. 5 shows only one IPv4 node (110-1) in the private IPv4 network (120-1) and one IPv6 node (510) in the public network (540), those skilled in the art will readily understand that the private IPv4 network (120-1) may include multiple IPv4 nodes (110), and the public network (540) may include multiple IPv6 nodes (540).

2. Public Network

The public network (540) shown in FIG. 5 may comprise any public IPv6-based network. The public network (540) is configured to support IPv6-based communications.

B. Example of a Method for Establishing Transparent Communication

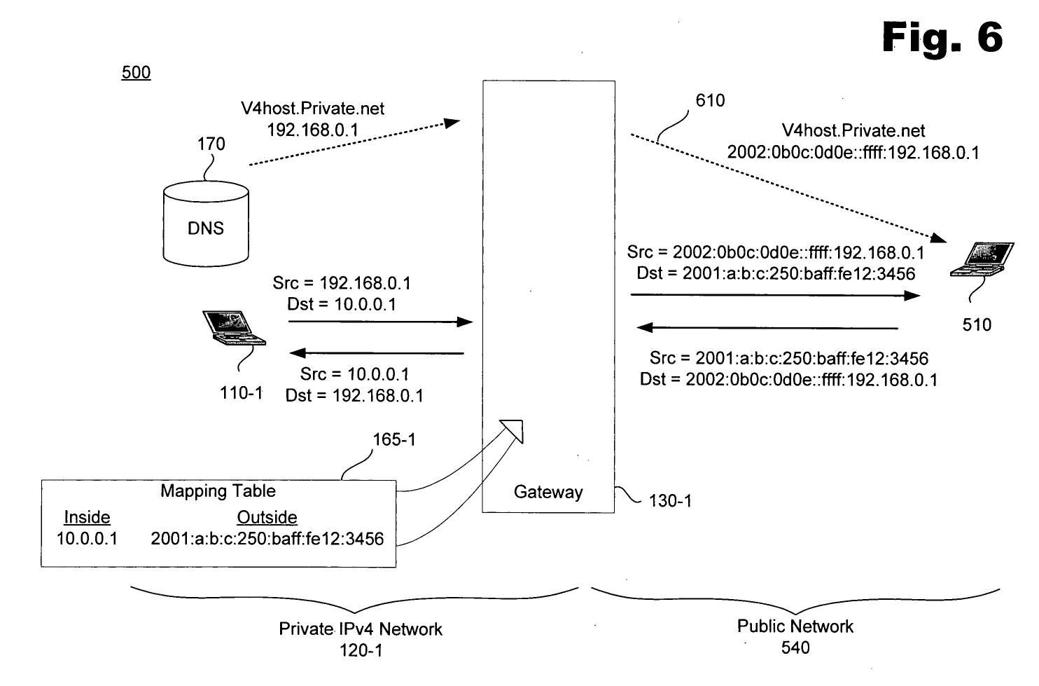

FIG. 6 is a block diagram illustrating addresses used for establishing a connection between the IPv6 node (510) and the IPv4 node (110-1) of the system (500) of FIG. 5, according to one embodiment. In the embodiment shown in FIG. 6, the IPv4 node (110-1) is assumed to have been assigned the fully qualified domain name of “V4host.Private.net.” The IPv4 node (110-1) is also assumed to have been assigned an IPv4 address that is unique within the private IPv4 network (120-1). FIG. 6 shows a case in which the IPv4 node (110-1) has been assigned the private address of “192.168.0.1.”

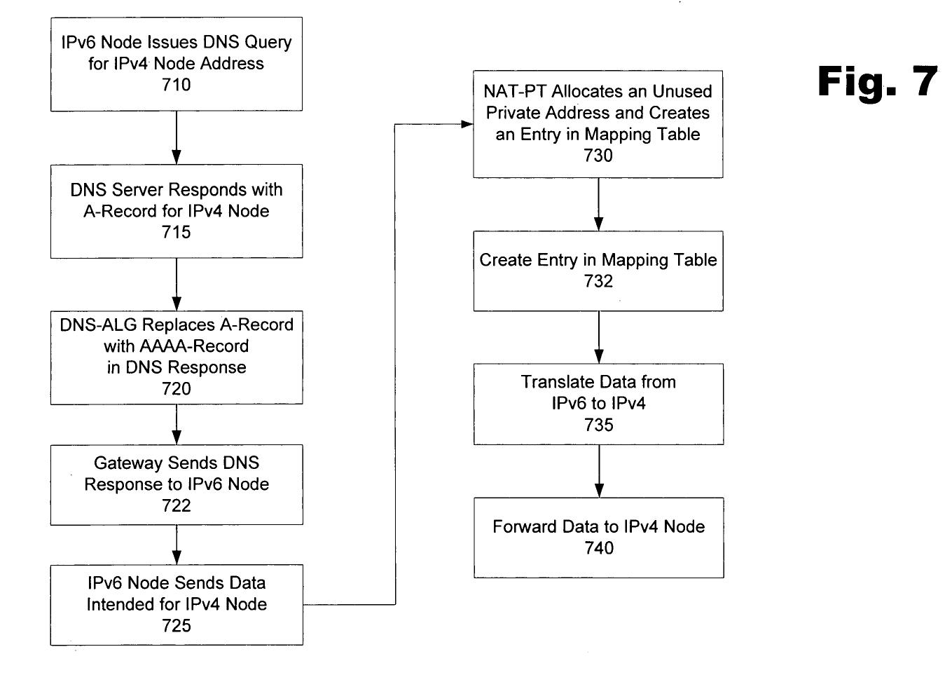

The gateway (130-1) of FIG. 6 has been assigned the globally routable IPv4 address of “11.12.13.14.” The gateway (130-1) of FIG. 6 has also been assigned an IPv6 prefix based on the gateway's (130-1) IPv4 address. The IPv6 prefix assigned to the gateway (130-1) of FIG. 6 is “2002:0b0c:0d0e:0/64.” The format of the IPv6 prefix is well-known to those skilled in the art. The addresses shown in FIG. 6 will be better understood with reference to the following discussion of FIG. 7. For the example shown in FIG. 7, the pool of private addresses available for the private IPv4 network (120-1) is assumed to be “10/8,” as understood by those skilled in the art.

FIG. 7 is a flowchart illustrating a method of establishing transparent communication between the IPv6 node (510; FIG. 6) and the IPv4 node (110-1; FIG. 6) of the system (500) of FIGS. 5 and 6, according to one embodiment. At step (710) of FIG. 7, the IPv6 node (510; FIG. 6) issues a query to the domain name system (DNS) to resolve the name, “V4host.Private.net,” for the IPv4 node (110-1; FIG. 6) to an IP address, as understood by those skilled in the art. The DNS server (170; FIG. 6) is the authoritative DNS server for the name “V4host.Private.net,” so the query is directed to DNS server (170; FIG. 6) in the private IPv4 network (120-1; FIG. 6).

At step (715), the DNS server (170; FIG. 6) responds to the query by providing an “A-record” associated with the name “V4host.Private.net.” The “A-Record” includes the local IPv4 address of “192.168.0.1” used in the private IPv4 network (120-1; FIG. 6) to identify the IPv4 node (110-1; FIG. 6).

At step (720), the DNS-ALG module (155-1; FIG. 5) of the gateway (130-1; FIG. 5) removes the “A-record” from the DNS response and replaces the “A-record” with an “AAAA-record.” The “AAAA-record” includes a unique and globally routable IPv6 address generated by the DNS-ALG module (155-1; FIG. 5), as discussed above. In FIG. 6, the generated IPv6 address includes the IPv6 prefix “2002:0b0c:0d0e:0/64” in commonly accepted form, which prefix is descriptive of the globally routable IPv4 address (11.12.13.14) of the gateway (130-1; FIG. 6). The IPv6 address also includes the private address (192.168.0.1) of the IPv4 node (110-1; FIG. 6), which private address is received from the DNS server (170; FIG. 6). The IPv6 prefix and the private address are arranged to form the globally unique and routable IPv6 address that can be used on the public side of the gateway (130-1; FIG. 6) to identify the IPv4 node (110-1; FIG. 6). As shown in FIG. 6, the “AAAA-record” inserted into the DNS response includes the IPv6 address of “2002:0b0c:0d0e::ffff:192.168.0.1.”

At step (722) of FIG. 7, the DNS response is sent from the gateway (130-1; FIG. 6) to the IPv6 node (510; FIG. 6), as shown by the path (610) in FIG. 6. From the information in the DNS response, the IPv6 node (510; FIG. 6) has located the IPv4 node (110-1; FIG. 6).

Processing may continue at step (725) of FIG. 7, at which step the IPv6 node (510; FIG. 6) sends data intended for the IPv4 node (110-1; FIG. 6). The IPv6 node (510; FIG. 6) may send the data intended for IPv4 (110-1; FIG. 6) to the gateway (130-1; FIG. 6). The data is typically in the form of packet data that includes a source IP address identifying the source node's IPv6 address and a destination IP address identifying the destination node's address in IPv6 format. For step (725) of FIG. 6, the source IP address is “2001:a:b:c:250:baff:fe12:3456,” and the destination IP address is “2002:0b0c:0d0e::ffff: 192.168.0.1.”

At step (730) of FIG. 7, the NAT-PT module (155-1; FIG. 5) allocates an unused address from the private address space of the private network (120-1; FIG. 6) to be associated with the public-side source address contained in the data packet received from the IPv6 node (510; FIG. 6), as discussed above. For example, the NAT-PT module (155-1; FIG. 5) may allocate “10.0.0.1” from the private address space. The unused address may be allocated when there is no entry containing the received source address (e.g., “2001:a:b:c:250:baff:fe12:3456”) in the NAT-PT mapping table (165-1; FIG. 6).

At step (732), the NAT-PT module (155-1; FIG. 5) creates an entry in the mapping table (165-1; FIG. 6) for the newly allocated address. In the case described above, the entry serves to map the IPv6 public-side address indicative of the source of the data (the IPv6 node (510; FIG. 6)) with the selected unused private address (e.g., IPv4 private-side address “10.0.0.1”), as shown in FIG. 6. By storing this mapping entry into the NAT-PT mapping table (165-1; FIG. 6), subsequent communications that are sent to the private-side address of “10.0.0.1” can be readily routed to the public side address “2001:a:b:c:250:baff:fe12:3456” based on the mapping table (165-1; FIG. 6), thereby allowing private IPv4 node (110-1; FIG. 6) to both receive incoming connections from and send data to IPv6 node (510; FIG. 6).

At step (735) of FIG. 7, the SIIT module (155-1; FIG. 5) of the gateway (130-1; FIG. 5) translates the IP header of the received data packet from IPv6 to IPv4 using addresses from the NAT-PT module (160-1; FIG. 5) of “10.0.0.1” for the source address and “192.168.0.1” for the destination address. “10.0.0.1” represents the private space source address of the IPv6 node (510; FIG. 6) as mapped to the public source address of the IPv6 node (510; FIG. 6), and “192.168.0.1” is the private address identifying the IPv4 node (110-1; FIG. 6) to which the data is destined.

At step (740), the gateway (130-1; FIG. 6) forwards the data to the IPv4 node (110-1; FIG. 6) identified by the destination address “192.168.0.1” in the private IP-based network (120-1; FIG. 6).

The method shown in FIG. 7 establishes mappings between private addresses and corresponding publicly routable IPv6 addresses. The mappings are stored in the gateway (130-1; FIG. 5) and are useful for establishing connections between public IPv6 devices and IPv4 devices in private networks. Subsequent communications between the IPv6 node (510; FIG. 5) and the IPv4 node (110-1; FIG. 5) are able to be forwarded to the indicated destinations by referencing NAT-PT mappings stored in the mapping table (165-1; FIG. 5).

The method shown in FIG. 7 may be implemented and used in many private networks, including already-deployed private networks.

### III. CONCLUSION

In conclusion, the system, method, and apparatus described above facilitate the establishment of transparent connections with IPv4 private address nodes by using IPv4-IPv6 address translation that generates globally routable IPv6 addresses for the IPv4 addresses. The unique IPv6 addresses include IPv4 address of the appropriate IPv4 node and the address of the node's gateway. This technique of mapping private IPv4 addresses to IPv6 addresses allows connections to be received and initiated with the IPv4 addresses.

Further, the gateway is configured to generate entries in a mapping table, which entries map public IPv6 source addresses with private IPv4 addresses. The gateway is able to consult the table to determine a routing destination for outgoing connections. If the source address for an incoming connection is not contained in the table, the gateway creates an entry for use in routing subsequent connections and data sent to the same IPv6 source. The gateway is able to associate the appropriate IPv4 addresses with incoming connections by extracting appropriate information from the IPv6 destination address contained in incoming data packets because the IPv6 destination address includes the private destination address.

The preceding description has been presented only to illustrate and describe embodiments of the invention. It is not intended to be exhaustive or to limit the invention to any precise form disclosed. Many modifications and variations are possible in light of the above teaching.

What is claimed is:

1. A system for facilitating establishment of communication with an Internet protocol version four (IPv4) node of a private network by using Internet protocol version six (IPv6), the IPv4 node being assigned an IPv4 private address, the system comprising:
a gateway configured to connect the IPv4 node with a public network, said gateway being assigned a globally routable IPv4 address, said gateway being configured to generate a globally routable IPv6 address based on the IPv4 private address of the IPv4 node and said globally routable IPv4 address of said gateway.

2. The system of claim 1, wherein said gateway is configured to generate said globally routable IPv6 address by embedding the IPv4 private address of the IPv4 node and said globally routable IPv4 address of said gateway in said globally routable IPv6 address.

3. The system of claim 1, wherein said gateway is configured to generate said globally routable IPv6 address by:
inserting said globally routable IPv4 address of said gateway into an IPv6 prefix; and
appending the IPv4 private address of the IPv4 node to said IPv6 prefix.

4. The system of claim 1, wherein said gateway is further configured to:
receive a message over the public network, said message including a globally routable source address in IPv6 format;
allocate an unused IPv4 private address from a predefined private address space of the private network; and
create a mapping, said mapping being configured to associate said unused IPv4 private address with said globally routable source address.

5. The system of claim 4, further comprising a mapping table configured to store said mapping.

6. The system of claim 5, wherein said gateway is further configured to:
receive a subsequent data packet, said subsequent data packet including a destination address in a first format;
identify a second destination address in a second format by querying said mapping table for said first format destination address, said first format destination address being associated with said second destination address by said mapping in said mapping table; and
forward said subsequent data packet to said second destination address, said second destination address being identified from said mapping.

7. The system of claim 6, wherein said first format comprises IPv4 format, said second format comprises IPv6 format, and said subsequent data packet is received from the IPv4 node of the private network.

8. The system of claim 4, wherein said globally routable source address comprises said globally routable IPv6 address.

9. The system of claim 4, wherein said message comprises a Domain Name System (DNS) response.

10. The system of claim 4, wherein said message comprises an incoming communication from either a public node of the public network or a second IPv4 node having a private address in an independent private network.

11. The system of claim 1, wherein said gateway is configured to:
receive a data packet over the public network, said data packet including a globally routable destination address in IPv6 format;
recognize when said globally routable destination address comprises said globally routable IPv6 address;
extract the IPv4 private address of the IPv4 node from said globally routable IPv6 address; and
forward said data packet to the IPv4 private address of the IPv4 node.

12. A system for facilitating establishment of communication with an Internet protocol version four (IPv4) node of a private network by using Internet protocol version six (IPv6), the IPv4 node being assigned an IPv4 private address, the system comprising:
a gateway configured to connect the IPv4 node with a public network, said gateway being assigned a globally routable IPv4 address, said gateway being configured to:
receive a message over the public network, said message including a globally routable source address in IPv6 format;
allocate an unused IPv4 private address from a predefined private address space of the private network; and
create a mapping, said mapping being configured to associate said unused IPv4 private address with said globally routable source address.

13. The system of claim 12, further comprising a mapping table configured to store said mapping.

14. The system of claim 13, wherein said gateway is further configured to:
receive a subsequent data packet, said subsequent data packet including a destination address in a first format;
identify a second destination address in a second format by querying said mapping table for said first format destination address, said first format destination address being associated with said second destination address by said mapping in said mapping table; and
forward said subsequent data packet to said second destination address, said second destination address being identified from said mapping.

15. The system of claim 14, wherein said first format comprises IPv4 format, said second format comprises IPv6 format, and said subsequent data packet is received from the IPv4 node of the private network.

16. The system of claim 12, wherein said message comprises a Domain Name System (DNS) response.

17. The system of claim 12, wherein said message comprises an incoming communication from either a public node of the public network or a second IPv4 node having a private address in an independent private network.

18. The system of claim 12, wherein said gateway is configured to:
receive a data packet over the public network, said data packet including a globally routable destination address in IPv6 format;
recognize when said globally routable destination address comprises said globally routable IPv6 address;
extract the IPv4 private address of the IPv4 node from said globally routable IPv6 address; and
forward said data packet to the IPv4 private address of the IPv4 node.

19. A method of facilitating establishment of communication with an Internet protocol version four (IPv4) address of an IPv4 node of a private network by using Internet protocol version six (IPv6), the IPv4 node being communicatively coupled to a public network by a gateway, the gateway being assigned a globally routable IPv4 address, the method comprising:
generating a globally routable IPv6 address based on the IPv4 private address of the IPv4 node and the globally routable IPv4 address of the gateway.

20. The method of claim 19, wherein said step of generating includes embedding the IPv4 private address of the IPv4 node and the globally routable IPv4 address of the gateway in said globally routable IPv6 address.

21. The method of claim 19, wherein said step of generating includes:
inserting the globally routable IPv4 address of the gateway into an IPv6 prefix; and
appending the IPv4 private address of the IPv4 node to said IPv6 prefix.

22. The method of claim 19, further comprising:
receiving a message over the public network, said message including a globally routable source address in IPv6 format;
allocating an unused IPv4 private address from a predefined private address space of the private network; and
creating a mapping, said mapping being configured to associate said unused IPv4 private address with said globally routable source address.

23. The method of claim 22, further comprising storing said mapping to a mapping table.

24. The method of claim 23, further comprising:
receiving a subsequent data packet, said subsequent data packet including a destination address in a first format;
identifying a second destination address in a second format by querying said mapping table for said first format destination address, said first format destination address being associated with said second destination address by said mapping in said mapping table; and
forwarding said subsequent data packet to said second destination address, said second destination address being identified from said mapping.

25. The method of claim 24, wherein said first format comprises IPv4 format, said second format comprises IPv6 format, and said subsequent data packet is received from the IPv4 node of the private network.

26. The method of claim 22, wherein said globally routable source address comprises said globally routable IPv6 address.

27. The method of claim 19, further comprising:
receiving a data packet over the public network, said data packet including a globally routable destination address in IPv6 format;
recognizing when said globally routable destination address comprises said globally routable IPv6 address;
extracting the IPv4 private address of the IPv4 node from said globally routable IPv6 address; and
forwarding said data packet to the IPv4 private address of the IPv4 node.

28. A method of facilitating establishment of communication with an Internet protocol version four (IPv4) address of an IPv4 node of a private network by using Internet protocol version six (IPv6), the IPv4 node being communicatively coupled to a public network by a gateway, the gateway being assigned a globally routable IPv4 address, the method comprising:
receiving a message over the public network, said message including a globally routable source address in IPv6 format;
allocating an unused IPv4 private address from a predefined private address space of the private network; and
creating a mapping, said mapping being configured to associate said unused IPv4 private address with said globally routable source address.

29. The method of claim 28, further comprising storing said mapping to a mapping table.

30. The method of claim 29, further comprising:
receiving a subsequent data packet, said subsequent data packet including a destination address in a first format;
identifying a second destination address in a second format by querying said mapping table for said first format destination address, said first format destination address being associated with said second destination address by said mapping in said mapping table; and
forwarding said subsequent data packet to said second destination address, said second destination address being identified from said mapping.

31. The method of claim 30, wherein said first format comprises IPv4 format, said second format comprises IPv6 format, and said subsequent data packet is received from the IPv4 node of the private network.

32. The method of claim 28, further comprising:
receiving a data packet over the public network, said data packet including a globally routable destination address in IPv6 format;
recognizing when said globally routable destination address comprises said globally routable IPv6 address;
extracting the IPv4 private address of the IPv4 node from said globally routable IPv6 address; and
forwarding said data packet to the IPv4 private address of the IPv4 node.

33. A processor-readable medium including instructions for facilitating establishment of communication with an Internet protocol version four (IPv4) private address of an IPv4 node of a private network by using Internet protocol version six (IPv6), the IPv4 node being communicatively coupled to a public network by a gateway, the gateway being assigned a globally routable IPv4 address, the instructions being configured to direct a processor to perform the step of:
generating a globally routable IPv6 address based on the IPv4 private address of the IPv4 node and the globally routable IPv4 address of the gateway.

34. The processor-readable medium of claim 33, wherein said step of generating includes embedding the IPv4 private address of the IPv4 node and the globally routable IPv4 address of the gateway in said globally routable IPv6 address.

35. The processor-readable medium of claim 33, wherein said step of generating includes:
inserting the globally routable IPv4 address of the gateway into an IPv6 prefix; and
appending the IPv4 private address of the IPv4 node to said IPv6 prefix.

36. The processor-readable medium of claim 33, wherein the instructions are further configured to direct the processor to perform the steps of:
receiving a data packet over the public network, said data packet including a globally routable destination address in IPv6 format;
recognizing when said globally routable destination address comprises said globally routable IPv6 address;
extracting the IPv4 private address of the IPv4 node from said globally routable IPv6 address; and
forwarding said data packet to the IPv4 private address of the IPv4 node.

37. A processor-readable medium including instructions for facilitating establishment of communication with an Internet protocol version four (IPv4) address of an IPv4 node of a private network by using Internet protocol version six (IPv6), the IPv4 node being communicatively coupled to a public network by a gateway, the gateway being assigned a globally routable IPv4 address, the instructions being configured to direct a processor to perform the steps of:
receiving a message over the public network, said message including a globally routable source address in IPv6 format;
allocating an unused IPv4 private address from a predefined private address space of the private network; and
creating a mapping, said mapping being configured to associate said unused IPv4 private address with said globally routable source address.

38. The processor-readable medium of claim 37, wherein the instructions are configured to direct the processor to perform a step of storing said mapping to a mapping table.

39. The processor-readable medium of claim 38, wherein the instructions are configured to direct the processor to perform the steps of:
receiving a subsequent data packet, said subsequent data packet including a destination address in a first format;
identifying a second destination address in a second format by querying said mapping table for said first format destination address, said first format destination address being associated with said second destination address by said mapping in said mapping table; and
forwarding said subsequent data packet to said second destination address, said second destination address being identified from said mapping.

40. The processor-readable medium of claim 39, wherein said first format comprises IPv4 format, said second format comprises IPv6 format, and said subsequent data packet is received from the IPv4 node of the private network.
